(19) United States
(12) Patent Application Publication
(10) Pub. No.: US 2005/0203822 A1
(43) Pub. Date: Sep. 15, 2005

(54) System and method of using life insurance to generate income

(76) Inventor: Mark A. Shea, Draper, UT (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 11/070,275

(22) Filed: Mar. 1, 2005

Related U.S. Application Data
(60) Provisional application No. 60/549,266, filed on Mar. 1, 2004.

(51) Int. Cl. G06F 17/60

(52) U.S. Cl. 705/36

(57) ABSTRACT

The invention includes a system and method of using life insurance to generate income for a property owner, the property owner's estate, and/or a developer of the land held by the property owner. One operation is identifying an insurable interest associated with a property and an individual with a property interest. Another operation is entering into a contractual relationship to create an insurable interest between a third party and the individual with a property interest to provide income to the individual with a property interest. Life insurance can be acquired on the life of the individual with a property interest in response to the contractual agreement. A face value of the life insurance is based at least in part on the property value. A financing party can also be permitted to pay premiums for the life insurance. The individual with a property interest can be paid at least a portion of the face value of the life insurance at least as early as a death benefit is paid.

### PRIORITY CLAIM

This application claims the benefit of U.S. Application No. 60/549,266 filed Mar. 1, 2004.

### FIELD OF THE INVENTION

The present invention relates generally to using life insurance to generate income.

### BACKGROUND

The ownership of land or real property has historically been a valuable asset. More recently, the value of land generally and more specifically near large cities has continued to increase. As a result, owners of such land have been able to realize significant gains in their property investments. One reason for the gain in real estate values has been the increasing demand for housing and commercial property near business areas and job centers. Property values have also increased in correlation with inflation and other economic factors. In addition, the ownership of land can bring particular tax advantages and investment advantages over time. For these reasons and others, property and real estate have been a good investment over the last several decades.

Despite the benefits of owning land, there can be a significant number of problems with converting property into cash or other intangible investment assets. Some of these problems are associated with governmental regulations and zoning ordinances for the property. For example, it can take a considerable amount of time, money, know-how and even attorney fees to change the zoning for a given property. In fact, changing the zoning or governmental regulations for a property can bring about a significant increase in the property value. In a similar manner, improving the property with buildings and/or other tangible improvements can also result in a significant gain of the property value.

Even when the cash value of the property is eventually realized through a sale of the property, another problem with converting the property to cash or cash equivalents is that there may be a significant amount of short or long term capital gains tax associated with this transfer. In addition, if a valuable property is being sold as the result of an estate or probate settlement there may be a significant amount of estate tax that must be paid to the government, which may increase the burden upon the deceased's estate to pay for these costs via the sale, a loan, or the use of other assets.

There are also other obstacles to selling a piece of property and one of these is when there are other partners involved in the property ownership. A partnership may pose a problem because the partners have different goals, have different lengths of time before retirement, or other compelling reasons to sell their property interest. Yet another risk in selling a property is the litigation risk that may be involved in selling an environmentally regulated or title disputed property.

Another problem with converting property into a cash asset is that the property owners may then need to determine how to reinvest the proceeds from the sale. Other investments such as stocks, bonds, or commodities are generally more volatile than simply retaining the property itself. As a result, many property owners retain the land itself even though a great monetary benefit can be realized from the sale of the property. In addition, there are also benefits that may be provided to the community when a prime piece of property is developed or otherwise improved. Unfortunately in many cases, benefits to the community cannot be realized in cases where the property is not developed and the property is held by the owner.

In order for property owners to sell or develop their property, the owners desire to mitigate their risk and overcome as many of the problems associated with the adverse financial consequences of selling the property as possible. When these risks are decreased, then a sale of the property can greatly benefit the property owner and possibly even the community at large.

### SUMMARY OF THE INVENTION

The invention includes a system and method of using life insurance to generate income for a property owner, the property owner's estate, and/or a developer of the land held by the property owner. One operation is identifying an insurable interest associated with a property and an individual with a property interest. Another operation is entering into a contractual relationship to create an insurable interest between a third party and the individual with a property interest to provide income to the individual with a property interest. Life insurance can be acquired on the life of the individual with a property interest in response to the contractual agreement. A face value of the life insurance is based at least in part on the property value. A financing party can also be permitted to pay premiums for the life insurance. The individual with a property interest can be paid at least a portion of the face value of the life insurance at least as early as a death benefit is paid.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a flow chart illustrating a method of using life insurance to generate income for a property owner, the property owner's estate, and/or a developer of the land held by the property owner in accordance with an embodiment of the present invention;

FIG. 2 is a block diagram illustrating an embodiment of setting up a system for using life insurance to generate income for a property owner, the property owner's estate, and/or a developer of the land held by the property owner;

FIG. 3 is a block diagram illustrating an embodiment of a system using life insurance to generate income after a death covered by the life insurance has occurred; and

FIG. 4 is a block diagram illustrating an embodiment of a system for using life insurance where the financing party is a third party other than a bank.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

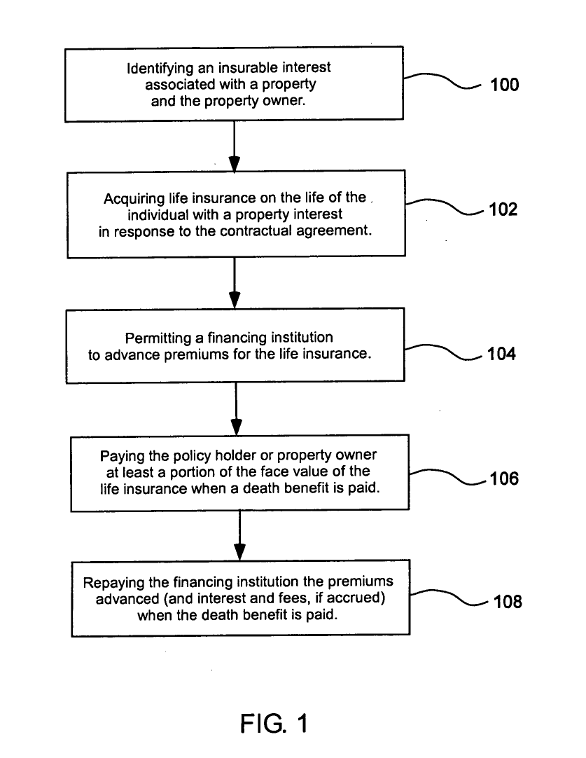

The present invention includes a system and method for using life insurance to generate income for a property owner, and/or the property owner's estate, and/or a developer of the land held by the property owner. This income can be used to offset many of the property owner's or land developer's difficulties and risks associated with the piece of property. FIG. 1 illustrates that the method includes the operation of identifying an insurable interest associated with a property and the property owner 100. In one embodiment of the invention, the property that will be identified may be a piece of real estate, a building that is built upon a piece of real estate, or water rights. The property owner, developer, or third party can have an insurable interest in that property or an insurable interest related to the property.

An insurable interest exists when an individual has a lawful and substantial interest in the life, health, and bodily safety of an insured person. Traditional areas where an insurable interest has existed is in a husband-wife relationship, a parent-dependent relationship, a relationship between business partners, and a relationship between a business and key employees.

A contract between an individual with an interest in the property and a third party can produce an insurable interest. Particularly, an insurable interest may exist if there is a financial relationship with money or consideration, a legal relationship (such as a contract), and/or the risk of financial harm to both parties. This insurable interest has not been recognized in the past and the present invention has identified the benefits that flow from using such an insurable interest.

For example, a contract for development of the land can be an insurable interest where specific buildings, shopping centers, or other structures fixed to the land are anticipated, existing, contracted or planned to increase the value of the land. Additional types of insurable interests may be a right of first refusal to purchase the land, buildings on the land, water rights, a right of first refusal to remove current buildings and acquire, entitle or develop the land, covering the risk of completing a transaction where the property may have an increased value, an option, the formation of a joint venture, or a lease.

The insurable interest can include an expected appreciation of the property over time or an anticipated entitlement value via some sort of government action which improves the property value. For example, a property may require government rezoning to realize the full value of the property. Re-zoning may use a significant amount of time, energy, money, and other resources that go into changing the property zoning. Thus, this anticipated entitlement can be an insurable interest.

A third party may also own all or part of the insurable interest associated with a property. For example, a land developer may have a contract with the property owner for the acquisition, entitlement, and development of the property, for a right of first refusal, or an option, etc. Thus, this interest by the third party can be considered an insurable interest.

Another operation in the present method is acquiring life insurance on the life of the property owner 102. One possible valuation for a death benefit in an insurance policy for the insurable interest related to property or real estate is the actual value of the real estate that is owned by the property owner. However, the valuation of an insurance policy is not limited simply to a property value because the valuation may be just a fraction of the property value. In other words, there is no minimum life insurance policy value that can be entered into by the parties. Alternatively, the insurance policy may be for the value of the property plus the property owner's assets (e.g., net worth). Simply controlling a property with an option or first right of refusal can bring value over time due to property appreciation or other opportunities, and the insurance policy's can be valued based on the expected appreciation. In one example, if the property value after government re-zoning is estimated to increase to $20,000,000, then the face value of the life insurance can be set to be at least that value or some fraction of the property value, such as $1,000,000.

If relatively large life insurance policies are desired based on the insurable interest associated with the property, a relatively large insurance premium is often paid to secure the life insurance (generally due to the advanced age and the insurable health rating of the life of the property owner). This life insurance premium may be paid by the policy owner or holder which may be the property owner or a third party who is involved in the insurable interest. However, the life insurance is more likely to be purchased by a third party on a leveraged or loaned premium basis. Thus, an additional operation in the present method is permitting a financing institution to lend or advance premiums for the life insurance 104. The loan interest and/or fees for loaning or advancing the premiums from the financing institution may be paid by the third party or accrued.

The life insurance purchased via the leveraged, loaned or advanced premiums may generally be what is known as whole life insurance or an equivalent universal life insurance. Other types of insurance can be used where the cash value of the insurance is not returned upon death, or alternatively the insurance policy my return the cash value and the death benefit. The configuration of the life insurance policy may affect the premiums that are paid to the life insurance company.

Further, the premiums loaned or advanced by the financing institution can be invested by the life insurance company to generate a return for the life insurance company which enables the life insurance company to generate a profit and distribute the death benefit. In addition, interest or dividends may accrue at a specified rate for the financing institution. The money invested by the life insurance company generates income to enable the life insurance company to generate the face value of the life insurance, and all or a portion of a fixed or variable interest rate that may be paid back to the financing institution.

The life insurance policy may be structured to include a Return of Premium rider where the policy owner will receive the life insurance premium(s) upon payment of the death benefit. In addition, the life insurance policy may be structured to include a Return of Interest rider that entitles the policy holder the receive all or a portion of the interest on a loan upon payment of the death benefit. Of course, various combinations of such riders can also be used.

The life insurance can be arranged for by the third party who owns or is involved in the insurable interest or by the property owner who has an insurable interest. When the property owner or property owners die, then a death benefit will be paid by the life insurance company to the policy owner or holder. This may include the operation of paying the policy holder (e.g., legal entity) at least a portion of the face value of the life insurance when a death benefit is paid 106. In addition, another portion of the death benefit or face value of the life insurance can be paid to a third party who may own the life insurance policy or the proceeds of the death benefit can be distributed as arranged under contract. In some situations the property owner may receive a payment and in other situations the property owner will not receive a payment. For example, a legal entity or LLC (limited liability company) can own the life insurance policy and may then distribute the death benefit to members of the LLC substantially tax free or as defined by tax law. Any parties who are not members of an LLC but receive distributions individually may pay taxes on those distributions.

The financing institution can also be paid the premiums loaned or advanced and interest, if accrued, when the death benefit is paid 108. The financing institution may also be repaid other amounts, in addition to the advanced or loaned premiums that were included in the loan such as closing fees, all or part of prepaid interest, or other costs that are included in the loan amount. Alternatively, the lender may desire to have the interest and/or fees on the loan paid over time as the interest is applied. Interest may be paid in arrears or in advance over time. In one example embodiment of the invention, this insurance can be structured as developer owned life insurance (DOLI).

As mentioned, all or a portion of the face value of the life insurance policy can be paid via the policy owner or holder to a legal entity or individual that does not have an ownership interest in the property, where the third party or legal entity has some ownership or involvement in the insurable interest. For example, an intended developer of the property may have an interest in the anticipated entitlement value of the property via an option or first right of refusal. This may include the situation where the developer is working toward obtaining the appropriate zoning regulations for that property. Accordingly, the third party property developer or the interested third party will have created an insurable interest or at least added to the insurable interest for the property. As a result, all or a portion of the face value of the life insurance can be contracted to be paid to the individual or legal entity doing the development or entitlement. As mentioned, members of a legal entity, such as an LLC, may be able to receive a tax free distribution of the death benefits from the LLC.

In order to obtain life insurance with the insurable interest associated with property, the third party or property owner may be required by the financing institution to supply a variable letter of credit or other collateral to the financing institution for a certain period of time. This variable letter of credit will generally be equal to all or part of the advanced or loaned amount. This letter of credit is required because the financing institution will be loaning the premiums for the life insurance and part of the premiums are used to cover insurance company administrative fees. Thus, the cash value portion of the premium of the life insurance will not build back up to the original premium amount loaned or advanced until a certain part of the life insurance period or term has passed by. For example, it may take from 10 to 12 years for the cash value of the life insurance to build up to equal the premium amounts advanced, at which time the need for the letter of credit may end. Thus, if the life insurance policy is cancelled before the cash value of the life insurance has built up, then the bank can take the cash surrender value and/or a variable portion of the letter of credit to cover the administration fees and other costs deducted from the premiums that have been paid to the life insurance company. When the life insurance owner lives an appropriate amount of time and the cash value meets or exceeds the premium (and interest accrued if any), as expected by the actuarial tables, then the letter of credit may decline or be eliminated and may not be used if the life insurance policy is cancelled. Instead, the cash surrender value may be utilized to retire the loan. The value of the variable letter credit can be equal to or greater than the value of the loan amount advanced if interest or other fees accrue. Alternatively, the letter of credit may not be necessary for the financing of the life insurance and the lender may not desire to have this security.

In addition to the letter of credit, the life insurance company or lender may also want an origination fee to set up the life insurance that covers the life of the property owner. This origination fee may come from a third party investor, a bank loan, a bank advance, from the property owner himself, or from the third party developer. In some situations, the payment of an origination fee may not be required or the premiums may be included in the leveraged or advanced premiums.

As discussed previously, the property that is involved in the present method may be an undeveloped, partially developed, developed piece of real estate, or real estate that is expected to have an increased value from a specific business purpose or due to appreciation. The property may have a single property owner, or there may be a group of property owners which have formed a partnership or legal entity to own or conduct business with the property.

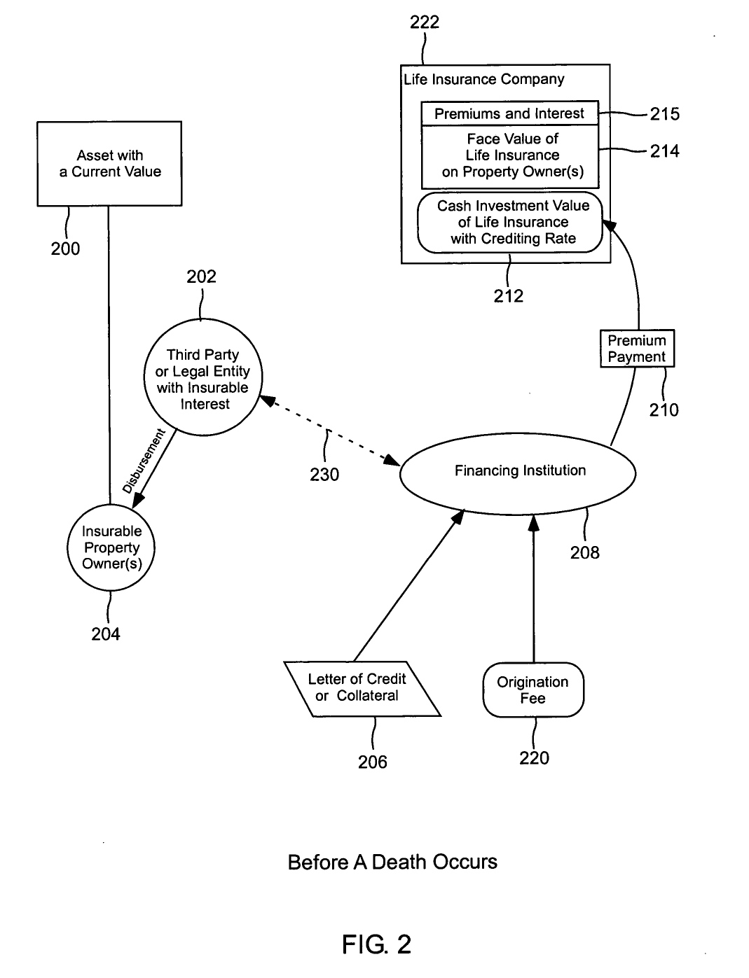

FIG. 2 is a block diagram illustrating the relationships between specific individuals, entities, and financial instruments in the present invention. The system of the present invention uses life insurance to generate income. An asset is identified that has a current value 200. This asset may be a piece of property, a building, a leased property, an intangible asset such as a right of first refusal, an option, water rights, or a tangible asset such as precious gems stored in a vault.

One example embodiment of the present system and method is a situation where a land developer agrees with a property owner or an individual with an interest in a property to obtain a first right of refusal (FRR) in return for life insurance purchased based on property owner's life and the insurable interest created by the first right of refusal. For example, the property owner (e.g., farmer) may have a $1 million dollar life insurance policy taken out upon his life based on the contracted insurable interest in a $15 million dollar property. Later, the property owner's estate may receive 5-25% of the death benefit upon the death of the property owner for providing the first right of refusal. This allows a third party to create an ongoing interest in a property while providing a future benefit for the property owner or his estate.

The specific property will have one or more insurable property owners 204. The insurable property owners are able to be insured by the life insurance company under the criteria defined for obtaining life insurance (e.g. insurable health and insurable interest, etc.). In addition, there may be parties who have a property interest that are not actual owners in the property. For example, a property owner's spouse may have a legal interest in the property through a will or trust. Such a party with a property interest may also be able to be covered by the life insurance if a life insurance company deems that the insurable interest is appropriate.

There may also be a party or legal entity who owns an insurable interest 202 that relates to the property. This insurable interest may also be owned in part by the insurable property owner's. An example of a third party having this insurable interest is a contract between the third party owners and the property owners. This contract may be a development contract for the property, a contract to obtain rezoning of the land, a contract to obtain other government action on the land, a first right of refusal, an option, an offer to purchase property, or any business purpose that generates the insurable interest.

Because the value of the life insurance on the life of a property owner may be relatively large, a financing institution 208 can be involved in the transaction to loan or advance money for the life insurance premiums and/or accrued interest. The premium payment 210 is taken by the life insurance company 222 and is used to generate investment returns for the life insurance company 212.

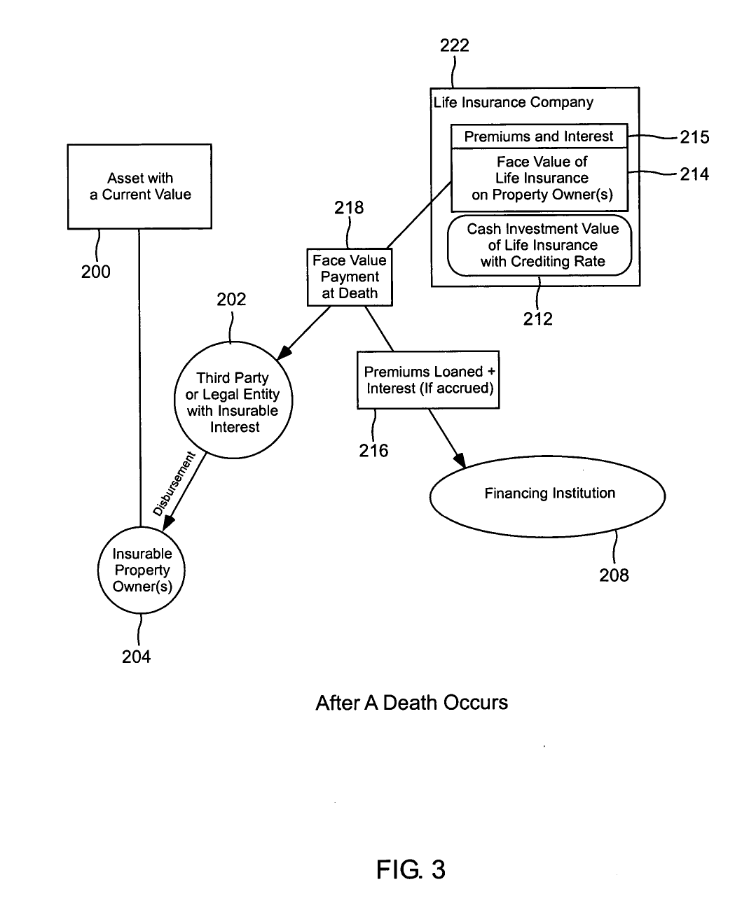

FIG. 3 illustrates the operation of the present invention after a death of the individual covered by the life insurance dies. When the death benefit of the life insurance is paid, the loan value or premium advanced can be repaid to the financing institution 216 with all or part the interest (if any). The loan or advanced value returned may include the original premiums and/or a stated amount of interest accrued on the loan acquired to advance the premiums to pay for the policy. The face value of the life insurance on the property owners 214 may also include the value of the transaction or risk covered. In addition, the face value of the life insurance may include the value of the property or value of additional assets of the property owners. The death benefits may also be structured to increase by the premium and/or all or part of the interest loaned or advanced by the financing institution 215.

When the death benefit is disbursed 218 as in FIG. 3, the face value of the life insurance 218 can be paid to the policy owners 202 after the bank has been repaid or it may be divided between the insurable property owners 204 and the third party 202. FIG. 3 illustrates that a portion of the face value payment 218 can be given to the insurable property owners 204. In addition, a portion of the face value can be given to the party with the insurable interest 202.

Referring again to FIG. 2, additional financing may be required to obtain the life insurance. For example, an origination fee 220 may be paid to the financing institution or life insurance company to initiate the life insurance. This origination fee for the loan or advance can be paid by a third party, the party with the insurable interest, the property owners, or included in the financing advanced by the financing institution. A letter of credit 206 or collateral from a third party or the entity holding the insurable interest to the financing institution may also be desired by the financing institution. This letter of credit may be a variable letter of credit that changes and will generally decrease as the cash surrender value of the life insurance policy increases. This protects the financing institution from losing the original value of their investment that may have initially been consumed by administrative fees in the event that the insurance policy owner cancels the insurance policy before the cash surrender value of the life insurance accumulates to equal the premium and/or the other amounts advanced.

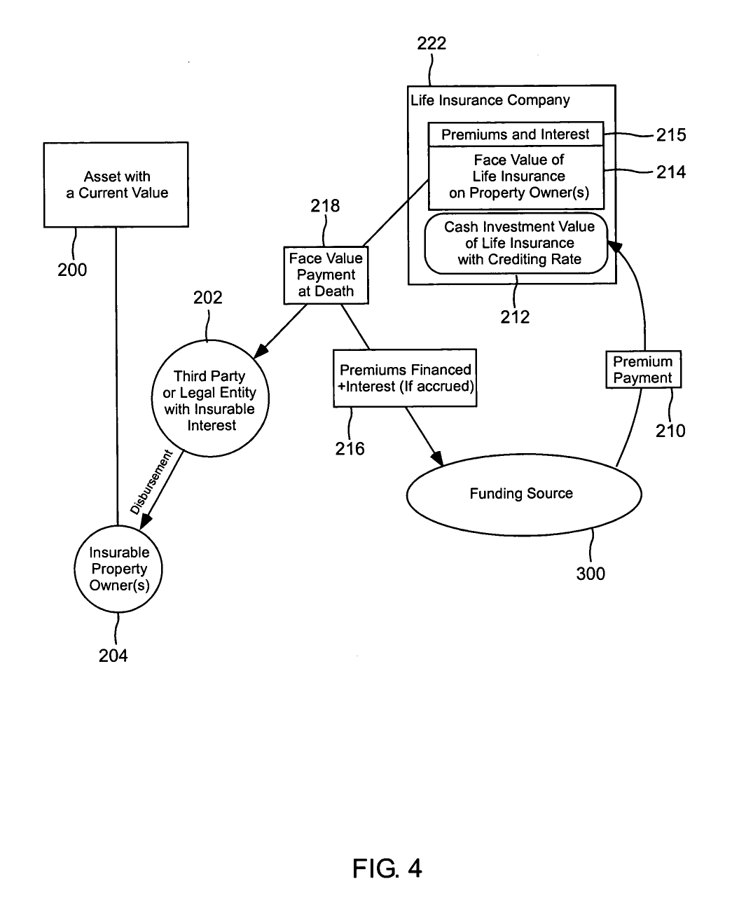

In an alternative embodiment of the invention illustrated in FIG. 4, a separate funding source 300 or independent financing can provide the financing as opposed to a financing institution or bank. The independent financing can come from the property owner, the third party, a developer, an independent investor who owns part of the legal entity holding the life insurance and insurable interest or another investment source.

One value of the present invention is that this system helps reduce some property owner's taxation problems related to the property. When the property owner dies, they may have to pay estate tax on a large portion of their assets. In contrast, the death benefit for the life insurance can be tax free. However, the life insurance benefits received can offset that estate tax so the value of the land still exists through the life insurance policy.

In one situation, the life insurance can also provide value to a third party who is able to go through an entitlement process to increase the value of the land. The life insurance can be an additional incentive to the third party to increase the market value of the property because the third party will also receive a portion of the proceeds from the life insurance. In a sense, this could even multiply the value of the initial asset to potentially recreate the asset value using life insurance. The present invention allows the life of the property owner to be insured and this can provide additional revenue back to the third party, the property developers, or property owner.

The present invention is also beneficial because the property owner can be a group of people who own the land. For example, a legal entity such as a corporation or LLC can be created with many partners. A class may then be created of individuals within that business entity who own a certain percentage of the partnership, meet a specific age criteria, have insurable health or additional criteria. Then a contract is made between the legal entity and members of that entity and the developer or third party to obtain life insurance based on an insurable interest, business purpose, and/or property value. Each of the individuals in the partnership can be insured for a specific value and then as they individually die, payments are made to the policy holder or owner and to repay the bank for the advance or loaned premiums. The payments to the policy holder or owner may then be distributed to partners in the entity holding the policy, a third party, the property owners, or others as specified by a contract. It may also be easier to have a group of individuals agree to allow life insurance to be obtained on their lives because each individual believes that they will outlive the other individuals in the group and each desires a portion of the proceeds of the other's death benefits. In addition, the present invention can insure individuals, spouses or any other combination of insurable individuals.

Thus a developer, a bank, or any other financing group who desires to implement the present invention can identify some group of people who have a property with value and an ownership in the property. Then a class of owners can be identified who have a specific attribute, financial status, or even one or more characteristics that identify an insurable person (e.g., an age exceeding a specific number of years). Life insurance may then be obtained based on the property value, a business purpose, etc. If the letter of credit, origination fee, and financing are obtainable, then the property is more likely to be insured to generate this additional income. The amount of insurance that can be purchased under the present invention is not limited and is dictated by the financial arrangements of those involved in the transaction.

In a sense, the value of the land together with the insurable interest of the land and the individual life of the property owners is actually invested via insurance and leveraged through the bank to generate additional income for the property owner and the third parties who have contracted with the property owner for the insurable interest.

In another embodiment of the invention, the value of the insurable interest created in one or more owners of a property can be turned into a marketable security. Shares in the value of this insurable interest pool can be sold to individuals who desire to purchase all or part of the insurable interest. In return for the shares, a dividend and/or the original principal may be paid when the death benefits are paid or the increase in value can be reinvested back into the fund to finance the purchase of additional life insurance for other pieces of property on which an insurable interest may exist. Thus, creating a tradable commodity from the insurable interest enables the sale of the insurability, resulting life benefits, life settlements, and/or death benefits.

The present invention also lends itself to many financing combinations depending on the insurable interest at issue, property value, age of the insured, health of the insured, net worth of the insured, net worth of the borrowers, and other variables.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. A method of using life insurance to generate income for a property owner, comprising:
identifying an insurable interest associated with a property and an individual with a property interest;
entering into a contractual relationship to create an insurable interest between a third party and the individual with a property interest to provide income to the individual with a property interest;
acquiring life insurance on the life of the individual with a property interest in response to the contractual agreement, wherein a face value of the life insurance is based at least in part on the property value;
permitting a financing party to pay premiums for the life insurance; and
paying the individual with a property interest at least a portion of the face value of the life insurance at least as early as a death benefit is paid.

2. A method as in claim 1, further comprising the step of paying the financing party the amounts paid for the life insurance when the death benefit is paid.

3. A method as in claim 1, further comprising the step of paying a portion of the face value of the life insurance to a legal entity that is a policy owner for the life insurance.

4. A method as in claim 1, further comprising the step of paying a portion of the face value of the life insurance to an individual that does not have an ownership interest in the property.

5. A method as in claim 4, further comprising the step of pooling a plurality of life insurance policies to create an investment portfolio.

6. A method as in claim 5, further comprising the step of using a financing party that has an insurable interest in the property.

7. A method as in claim 6, further comprising the step of using a financing party that has in interest in the insurable interest.

8. A method as in claim 1, further comprising the step of acquiring life insurance that is whole life insurance, universal life insurance or an equivalent life insurance.

9. A method as in claim 1, further comprising the step of using an insurable interest selected from the group of: a land development interest, a right of first refusal, covering a risk of completing a transaction where the property may have an increased value, an option, formation of a joint venture, and a lease.

10. A method of using life insurance to generate income for a property owner, comprising:
identifying an insurable interest associated with a property and the property owner;
acquiring life insurance on the life of the property owner wherein a face value of the life insurance is based at least a portion of the property value;
permitting a financing institution to advance premiums for the life insurance;
paying the property owner at least a portion of the face value of the life insurance at least as early as a death benefit is paid; and
repaying the financing institution the amounts advanced for the life insurance when the death benefit is paid.

11. A method as in claim 1, further comprising the step of paying a portion of the face value of the life insurance to a legal entity that does have an insurable interest in the property.

12. A method as in claim 1, further comprising the step of paying a portion of the face value of the life insurance to an individual that does not have an ownership interest in the property.

13. A method as in claim 11, further comprising the step of supplying a variable letter of credit or collateral from a third party or property owner to the financing institution.

14. A method as in claim 13, further comprising the step of using an amount the premiums have been reduced by administrative fees as a basis for the variable letter of credit or collateral.

15. A method as in claim 1, further comprising the step of paying an origination fee for the advance from a third party or property owner.

16. A method as in claim 1, wherein the step of identifying a property with an insurable interest, further comprises the step of identifying a property having one or more property owners.

17. A method as in claim 1, further comprising the step of acquiring life insurance that is whole life insurance, universal life insurance or an equivalent life insurance.

18. A method of using life insurance to generate income for a property owner, comprising:
identifying an insurable interest associated with a property and the property owner;
acquiring life insurance on the life of the property owner wherein a face value of the life insurance is based on at least a portion of the property value;
contracting between the property owner and a third party to distribute the proceeds of the life insurance death benefit;
permitting a financing institution to advance premiums for the life insurance;
supplying a variable letter of credit from the property owner or third party to the financing institution;
allowing the property owner or third party to pay origination fees for the bank advance;
paying the property owner at least a portion of the face value of the life insurance when a death benefit is paid;
paying the third party at least a portion of the face value of the life insurance when a death benefit is paid; and
repaying the financing institution the amount advanced for the life insurance with accrued interest when the death benefit is paid.

19. A method as in claim 20, further comprising the step of acquiring life insurance that is whole life insurance, universal life insurance or an equivalent life insurance.

20. A method as in claim 20, further comprising the step of acquiring an insurable interest selected from the group of: a land development interest, a right of first refusal, covering a risk of completing a transaction where the property may have an increased value, an option, formation of a joint venture, and a lease.
